(19) United States
(12) Patent Application Publication
(10) Pub. No.: US 2009/0058919 A1
(43) Pub. Date: Mar. 5, 2009

(54) INK-JET RECORDING DEVICE

(75) Inventor: Kenta HORADE, Kiyosu-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/199,755

(22) Filed: Aug. 27, 2008

(30) Foreign Application Priority Data
Aug. 31, 2007 (JP) 2007-226165

(51) Int. Cl. B41J 29/393

(52) U.S. Cl. 347/19

(57) ABSTRACT

An ink-jet recording device includes an image forming unit and a maintenance-process performing unit. The image forming unit forms an image on a recording medium having a first surface and a second surface. The image forming unit includes a recording head ejecting ink droplets onto the first surface to form a first image thereon, and ejecting ink droplets onto the second surface to form a second image thereon after forming the first image. The maintenance-process performing unit performs a maintenance process for improving a quality of the second image, within a standby time period after forming of the first image is finished and before forming of the second image is started.

### CROSS REFERENCE TO RELATED APPLICATION

This application claims priority from Japanese Patent Application No. 2007-226165 filed Aug. 31, 2007. The entire content of this application is incorporated herein by reference.

### TECHNICAL FIELD

The present invention relates to an ink-jet recording device capable of forming an image on both sides of a recording medium.

### BACKGROUND

An ink-jet recording device capable of forming an image on front-back both sides of a recording medium (recording sheet) is known (for example, see Japanese Patent Application Publication No. H11-209008). This type of ink-jet recording device takes a recording medium from a sheet-feeding tray, and then feeds the recording medium along a sheet-feeding path. A recording unit, which is provided in a middle portion of the sheet-feeding path, forms an image on the front side of the recording medium. After that, the recording medium is held by a switch back roller pair, and fed to an inversion path. The recording medium is sent to the upstream side of the sheet-feeding path (upstream to the recording unit). In this case, the recording medium has been flipped from side to side. The recording unit forms an image on the back side of the flipped recording medium. The recording medium is then discharged.

### SUMMARY

However, when forming an image on both side of the recording medium in the above manner, some waiting time is required after forming an image on the front side of the recording medium, before forming an image on the back side thereof, until the ink applied on the front side is dried. The ink-jet recording device performs no operations during the waiting time, which means that the waiting time is not utilized effectively.

In view of the above-described drawbacks, it is an objective of the present invention to provide an ink-jet recording device capable of effectively utilizing a standby time period required for forming an image on both sides of a recording medium.

In order to attain the above and other objects, the present invention provides an ink-jet recording device including an image forming unit and a maintenance-process performing unit. The image forming unit forms an image on a recording medium having a first surface and a second surface. The image forming unit includes a recording head ejecting ink droplets onto the first surface to form a first image thereon, and ejecting ink droplets onto the second surface to form a second image thereon after forming the first image. The maintenance-process performing unit performs a maintenance process for improving a quality of the second image, within a standby time period after forming of the first image is finished and before forming of the second image is started.

Another aspect of the present invention provides an ink-jet recording method in an ink-jet recording device forming a first image on a first surface of a recording medium, and forming a second image on a second surface of the recording medium. The method includes forming the first image; and performing a maintenance process for improving a quality of the second image, after forming of the first image is finished and before forming of the second image is started.

### BRIEF DESCRIPTION OF THE DRAWINGS

The particular features and advantages of the invention as well as other objects will become apparent from the following description taken in connection with the accompanying drawings, in which:

FIG. 1 is a perspective view of an appearance of a multi-functional printer 10;

FIG. 2 is a cross sectional view showing the multi-functional printer 10;

FIG. 3 is a plan view showing an essential part of a printing unit 11;

FIG. 4 is a plan view showing a configuration of a purge mechanism 56;

FIG. 5 is a plan view showing the bottom of a carriage 38;

FIG. 6 is a fragmentary sectional view schematically showing the cross section of a media sensor 86;

FIG. 7 is a block diagram showing a configuration of a control unit 84 of the multi-functional printer 10;

FIG. 8 is a flowchart showing a process to be performed when the multi-functional printer 10 forms an image on both sides of a recording sheet;

FIG. 9 is a flowchart showing a maintenance process; and

FIG. 10 is a flowchart showing a process of extracting one or more maintenance processes from all maintenance processes which have been stored in advance.

### DETAILED DESCRIPTION

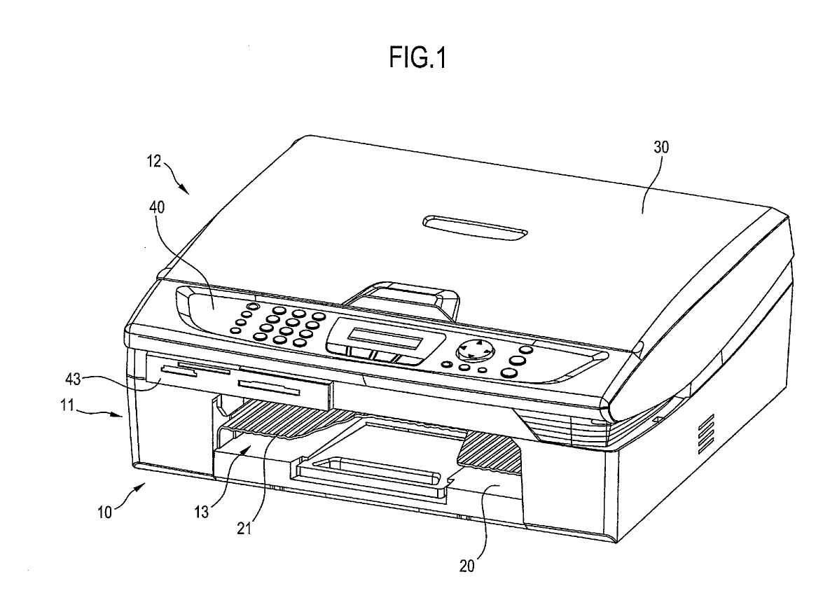

The overall configuration of a multi-functional printer 10 according to the embodiment of the present invention is described with reference to FIG. 1. FIG. 1 is a perspective view of an appearance of the multi-functional printer 10. The multi-functional printer 10 is a multi function device (MFD) including a printing unit 11 and a scanning unit 12. The multi-functional printer 10 has a printing function, a scanning function, a copy function, and a facsimile function. The ink-jet recording device according to the present invention is implemented as the printing unit 11 of the multi-functional printer 10. Therefore, in the multi-functional printer 10, the functions except the printing function are arbitrary.

The printing unit 11 can perform printing on front-back both sides of a recording sheet. The printing unit 11 will be described later in detail in terms of its configuration and operation. As shown in FIG. 1, a scanning unit 12 is provided in an upper portion of the multi-functional printer 10. The scanning unit 12 is a so-called flat bed scanner. A scanner cover 30 is provided as a top plate of the multi-functional printer 10. Although not shown in the figure, a platen glass is provided below the scanner cover 30 so that an original document is placed thereon. An image of the original document is read in a state that the original document is covered with the scanner cover 30.

An operation panel 40 is provided on the front-surface of the multi-functional printer 10. The operation panel 40 has various types of operation buttons and a liquid crystal display section to allow a user to operate the printing unit 11 and the scanning unit 12. The multi-functional printer 10 is operated based on an instruction provided through the operation panel 40. For example, the user sets a type of a recording sheet (plain paper, coated paper, or glossy paper in the embodiment) through the operation panel 40. The user also sets a recording mode of the multi-functional printer 10 to either one of a single-sided print mode of recording an image only on the front side of a recording sheet, or a double-sided print mode of recording an image on front-back both sides of a recording sheet, through the operation panel 40.

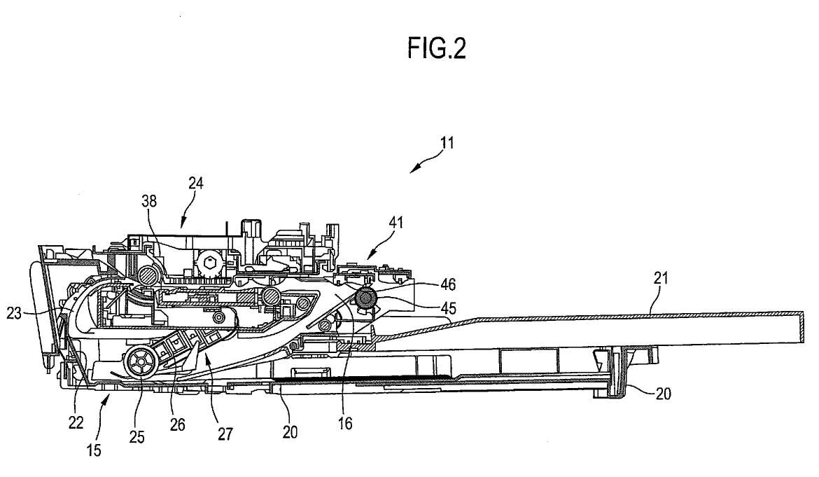

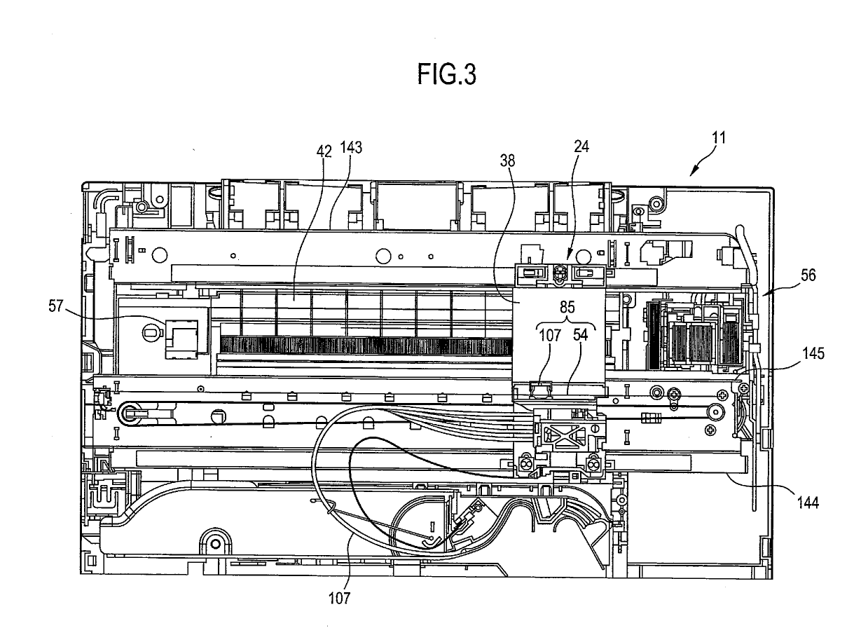

The multi-functional printer 10 further includes a slot section 43. Various types of small memory cards as storage media can be loaded in the slot section 43. Next, a configuration of the printing unit 11 is described with reference to FIG. 1 to FIG. 3. FIG. 2 is a longitudinal sectional view showing the configuration of the printing unit 11 included in the multi-functional printer 10. FIG. 3 is a plan view showing an essential part of the printing unit 11. The printing unit 11 includes a feeding unit 15, a recording unit 24, a sheet-flipping guide 16, a path-switching unit 41, and a guiding unit 76.

As shown in FIG. 2, the feeding unit 15 is provided in a bottom portion of the printing unit 11. The feeding unit 15 includes a sheet-feeding tray 20 for holding a stack of recording sheets, a sheet-feeding arm 26, a sheet-feeding roller 25, and a power transmission mechanism 27 for driving the sheet-feeding roller 25. As shown in FIG. 1, an opening 13 is provided on the front surface of the printing unit 11 so that the sheet-feeding tray 20 and a discharge tray 21 are arranged one above the other inside the opening 13.

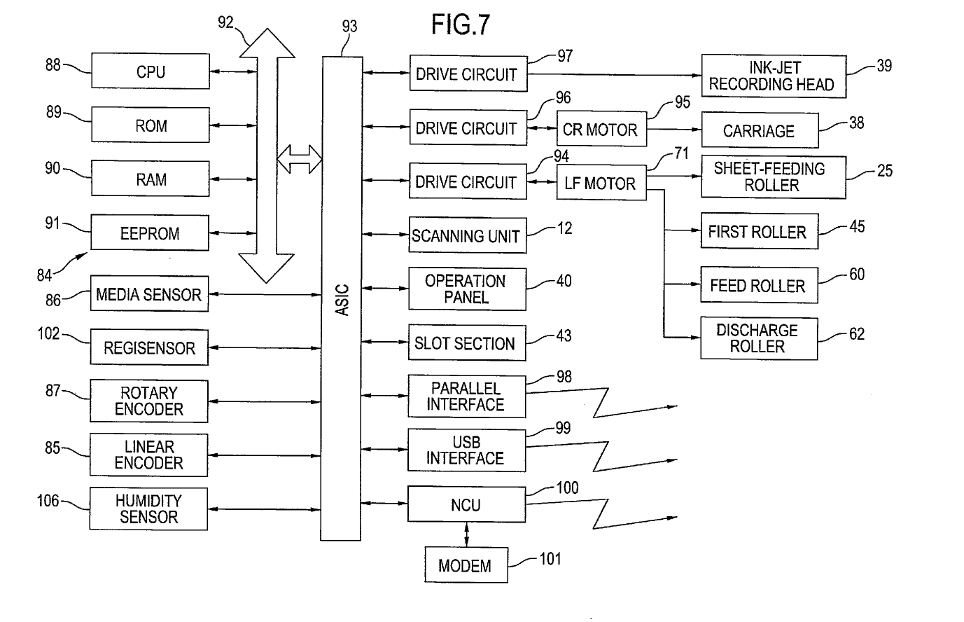

The sheet-feeding roller 25, which is pivotally supported by the end of the sheet-feeding arm 26, is positioned above the sheet-feeding tray 20. The sheet-feeding roller 25 is rotated by a not shown LF motor 71 (see FIG. 7) through the power transmission mechanism 27. The sheet-feeding roller 25 is usually in contact with (by applying pressure) the topmost sheet on the paper stack on the sheet-feeding tray 20. As the sheet-feeding roller 25 rotates, the topmost sheet is sent toward an inclined separation plate 22, by the friction force occurring between the topmost sheet and the surface of the sheet-feeding roller 25.

The inclined separation plate 22, which is provided in a back portion of the sheet-feeding tray 20, leads to a sheet-feeding path 23. As the leading edge of a recording sheet makes contact with the inclined separation plate 22, the recording sheet is guided upward so as to be fed into the sheet-feeding path 23.

The sheet-feeding path 23 bends upward along the inclined separation plate 22, and then turns toward the front side of the multi-functional printer 10 into a U-shape. The sheet-feeding path 23 extends from the rear side of the multi-functional printer 10 (left in FIG. 2) to the front side thereof (right in FIG. 2) through the recording unit 24, and then leads to the discharge tray 21. At a position where the sheet-feeding path 23 bends, rollers (not shown) are provided in a freely rotating manner so that a recording sheet can be fed smoothly even at the position.

The recording unit 24 is provided in a middle portion of the sheet-feeding path 23. The recording unit 24 includes a carriage 38; and an ink-jet recording head 39 mounted on the carriage 38. The carriage 38 reciprocates in a main scanning direction (direction perpendicular to the plane of FIG. 2) along guide rails 143 and 144. Specifically, the carriage 38 is driven by a CR motor 95 (see FIG. 7), and slid through a belt drive mechanism, for example.

Inside the multi-functional printer 10, not shown ink cartridges are provided independently of the ink-jet recording head 39. Ink is supplied from each ink cartridge to the ink-jet recording head 39 through ink tubes 107. While the carriage 38 is reciprocating, the ink-jet recording head 39 ejects tiny droplets of ink, thereby performing printing on a recording sheet fed on the platen 42.

The sheet-flipping guide 16 flips a recording sheet from side to side, and then guides the flipped sheet onto the sheet-feeding tray 20. As shown in FIG. 2, the sheet-flipping guide 16 connects to a portion downstream from the recording unit 24, of the sheet-feeding path 23. The sheet-flipping guide 16 extends obliquely downward, toward the sheet-feeding roller 25, from the downstream side of the sheet-feeding path 23.

The printing unit 11 includes a linear encoder 85. The linear encoder 85 includes encoder strips 54 arranged along a marginal part 145 of the guide rail 144; and an optical sensor 107 mounted on the carriage 38, for detecting each encoder strip 54. The linear encoder 85 detects the position of the carriage 38 while the carriage 38 is reciprocating.

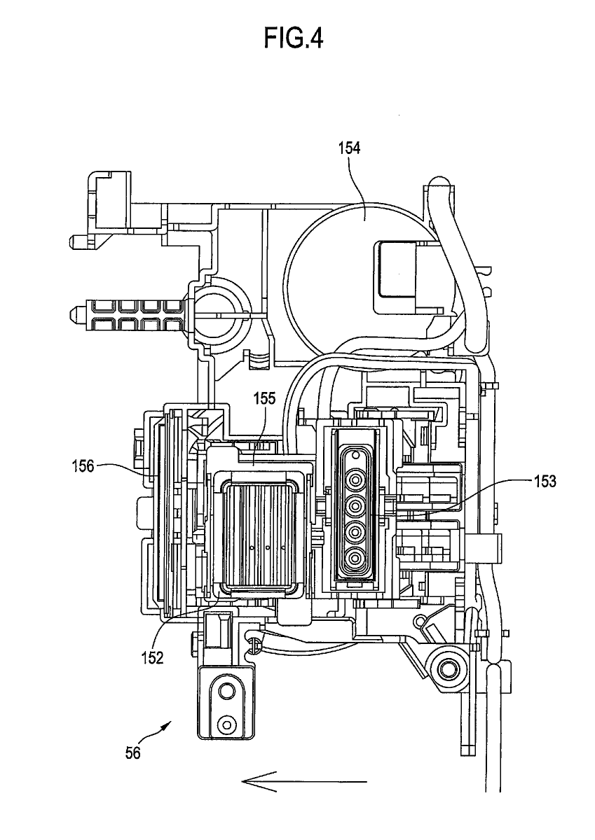

Beyond the range where the ink-jet recording head 39 records an image (to the right side of the sheet of FIG. 3), a purge mechanism 56 is provided. FIG. 4 is a plan view showing a configuration of the purge mechanism 56. The purge mechanism 56 removes air bubbles and foreign matter from the nozzles of the ink-jet recording head 39 by suction. As shown in FIG. 4, the purge mechanism 56 includes a nozzle cap 152, an exhaust cap 153, a pump 154, a lifting-up mechanism 155, and a wiper blade 156.

The nozzle cap 152 is a rubber cap for covering the nozzles of the ink-jet recording head 39. The exhaust cap 153 is a rubber cap connecting to a port (not shown) of the ink-jet recording head 39. The pump 154 is a so-called rotary pump connected either to the nozzle cap 152 or the exhaust cap 153, for suction. The lifting-up mechanism 155 brings the nozzle cap 152 and the exhaust cap 153 into contact with the ink-jet recording head 39. The lifting-up mechanism 155 also separates the nozzle cap 152 and the exhaust cap 153 therefrom. The wiper blade 156 wipes ink from the exhaust surface and the nozzle surface of the ink-jet recording head 39.

When the purge mechanism 56 removes air bubbles and the like from the ink-jet recording head 39, the carriage 38 moves so that the ink-jet recording head 39 is positioned above the nozzle cap 152 and the exhaust cap 153. Specifically, the carriage 38 moves so that the nozzles are positioned above the nozzle cap 152, as well as so that the port is positioned above the exhaust cap 153. As a contact lever (not shown) is pushed toward the carriage 38, the lifting-up mechanism 155 moves the nozzle cap 152 and the exhaust cap 153 to a close contact position. As a result, the nozzle cap 152 makes close contact with the nozzle surface so that the periphery of the nozzles is hermetically closed, and the exhaust cap 153 makes close contact with the exhaust surface so that the periphery of the port is hermetically closed.

The platen 42 faces the ink-jet recording head 39. Within the range where the carriage 38 reciprocates, the platen 42 covers a central portion through which a recording sheet passes. The platen 42 is in parallel with the guide rails 143 and 144 at a predetermined interval. As a result, the undersurface of the ink-jet recording head 39 mounted on the carriage 38 which moves slidingly on the guide rails 143 and 144, faces the top surface of the platen 42 at a predetermined head gap.

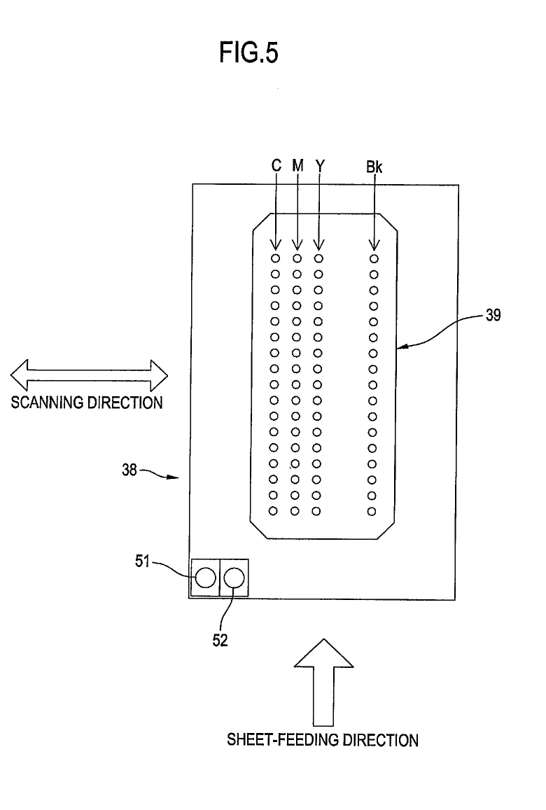

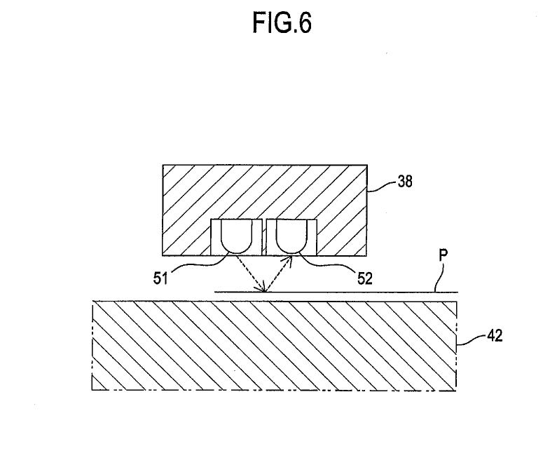

As mentioned above, the carriage 38 includes the media sensor 86 (see FIG. 7). Referring to FIG. 5, the media sensor 86 is provided on the undersurface of the carriage 38. As shown in FIG. 5 and FIG. 6, the carriage 38 includes an photo emitting unit 51 having light emitting diodes, and a photoreceptor unit 52 having an optical sensor. The photo emitting unit 51 irradiates the platen 42 with light. The irradiated light is reflected on the front side of the platen 42. The photoreceptor unit 52 then receives the reflected light, and produces an output according to the amount of the received light. The output is indicated as a so-called AD value (voltage value).

The multi-functional printer 10 includes a waste ink tray 57. The waste ink tray 57 is provided within the range where the carriage 38 reciprocates, beyond the image recording range. The waste ink tray 57 is integrally formed with the platen 42 as one. A foam for absorbing waste ink is provided on the front side of the waste ink tray 57.

Referring to FIG. 2, the path-switching unit 41 is downstream from the recording unit 24, along the sheet-feeding path 23. The path-switching unit 41 includes a first roller 45 and a second roller 46 as a roller pair.

The first roller 45 is connected with the LF motor 71 through a required drive transmission mechanism (not shown). The first roller 45 is rotated by the LF motor 71 in either a forward or reverse direction. As a recording sheet has been fed along the sheet-feeding path 23, the recording sheet is held by the first roller 45 and the second roller 46. As the first roller 45 rotates in the forward direction, the recording sheet is fed to the downstream side in the sheet-feeding direction, in a state that the recording sheet remains held by the first roller 45 and the second roller 46. The recording sheet is then discharged to the discharge tray 21. On the other hand, as the first roller 45 rotates in the reverse direction, the recording sheet is returned to the upstream side in the sheet-feeding direction, in the state that the recording sheet remains held by the first roller 45 and the second roller 46.

Next, a control system of the multi-functional printer 10 is described with reference to FIG. 7. FIG. 7 is a block diagram showing a configuration of a control unit 84 of the multi-functional printer 10. The control unit 84 controls not only the printing unit 11, but also the multi-functional printer 10 as a whole, including the scanning unit 12. The control unit 84, which includes a main board, is disposed at a predetermined position within a main frame 53. Since a configuration for controlling the scanning unit 12 is not a critical feature of the present invention, its detailed description is omitted here.

As shown in FIG. 7, the control unit 84 includes a microcomputer mainly having a CPU (Central Processing unit) 88, a ROM (Read only Memory) 89, a RAM (Random Access Memory) 90, an EEPROM (Electrically Erasable and Programmable ROM) 91. The control unit 84 is connected to an ASIC (Application Specific Integrated Circuit) 93 through a bus 92.

The ROM 89 stores programs for controlling various operations of the multi-functional printer 10. The RAM 90 is used as a work area or a storage area for temporarily storing various kinds of data to be used when the CPU 88 executes each of the programs. The EEPROM 91 stores settings and flags to be retained even after the multi-functional printer 10 is powered off.

Based on an instruction of the CPU 88, the ASIC 93 produces a phase excitation signal or the like for energizing the LF motor 71. The signal is sent to a drive circuit 94 of the LF motor 71 so that the drive signal then energizes the LF motor 71 through the drive circuit 94, thereby controlling the rotation of the LF motor 71.

In response to the signal outputted from the ASIC 93, the drive circuit 94 produces an electric signal for rotating the LF motor 71. The LF motor 71 rotates in response to the electric signal. The torque of the LF motor 71 is transmitted to the sheet-feeding roller 25, a feed roller 60, discharge roller 62, and the first roller 45.

Based on an instruction of the CPU 88, the ASIC 93 produces a phase excitation signal or the like for energizing the CR motor 95. The signal is sent to a drive circuit 96 of the CR motor 95 so that the drive signal energizes the CR motor 95 through the drive circuit 96, thereby controlling the rotation of the CR motor 95.

In response to the signal outputted from the ASIC 93, the drive circuit 96 produces an electric signal for rotating the CR motor 95. The CR motor 95 rotates in response to the electric signal. The torque of the CR motor 95 is transmitted to the carriage 38 through a required drive mechanism, thereby reciprocating the carriage 38.

A drive circuit 97 drives the ink-jet recording head 39 at a predetermined time interval. Based on the drive control procedure outputted from the CPU 88, the ASIC 93 produces an output signal. Based on the output signal, the drive circuit 97 controls the drive of the ink-jet recording head 39. The drive circuit 97 outputs a signal, and the signal is sent from the main board to a head control board included in the control unit 84. The ink-jet recording head 39 then selectively ejects each color of ink onto a recording sheet at a predetermined time interval. The signal outputted from the drive circuit decides the amount of ink to be ejected from the ink-jet recording head 39.

There are provided a rotary encoder 87 for detecting the amount of the rotation of the feed roller 60; a linear encoder 85 for detecting the position of the carriage 38; a regisensor 102 for detecting the leading and trailing edges of a recording sheet; the media sensor 86 for detecting the presence of the recording sheet on the platen 42; a humidity sensor 106 for detecting the humidity in an atmosphere for image recording. These constitutional elements are connected to the ASIC 93.

When the CPU 88 determines the type of a recording sheet by the operation panel 40 or a printer driver or the like stored in a personal computer, the determination data is temporarily stored in the RAM 90 for a double-sided print process. There are also provided an NCU (Network Control Unit) 100, a modem 101, a parallel interface 98, a USB interface 99, for implementing a facsimile function. These constitutional elements may be connected to the ASIC 93.

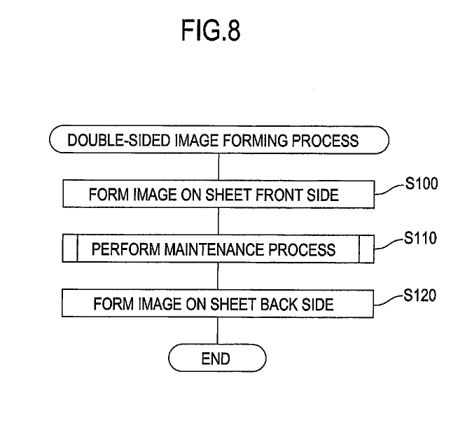

Next, a description is given for a process to be performed when the multi-functional printer 10 forms an image on both sides of a recording sheet (when the recording mode of the multi-functional printer 10 is set to the double-sided print mode), with reference to flowcharts of FIG. 8 to FIG. 10.

The process is described as a whole with reference to the flowchart of FIG. 8. In Step 100, the CPU 88 forms an image on the front side of a recording sheet. Specifically, a recording sheet is taken out from the sheet-feeding tray 20; fed along the sheet-feeding path 23, and then led to the recording unit 24. The recording unit 24 forms an image on the front side of the recording sheet. In this case, a setting has been made so that a given image is to be formed on the front side.

The recording sheet is intermittently fed, and the carriage 38 slides in a state that the recording sheet is suspended, in order to form the image. Specifically, while the ink-jet recording head 39 ejects ink droplets with the sliding of the carriage 38, the recording sheet is suspended. While the ink-jet recording head 39 is ejecting no ink droplets, the recording sheet is fed by a predetermined linefeed width.

In Step 110, the CPU 88 performs a predetermined maintenance process. The maintenance process will be described later in detail. In Step 120, the CPU 88 forms the image on the back side of the recording sheet, after the image forming on the front side is finished, after a lapse of a predetermined ink-drying time A (standby time period). Specifically, first, as shown in FIG. 2, the first roller 45 and the second roller 46 holds and feeds the recording sheet until the leading edge of the recording sheet reaches the discharge tray 21. The first roller 45 and the second roller 46 then rotates in the reverse direction to send the recording sheet to the sheet-flipping guide 16 so that the recording sheet returns onto the sheet-feeding tray 20. In this case, the recording sheet has been flipped from side to side.

Next, similarly to Step 100, the recording unit 24 forms an image on the back side of the recording sheet. In this case, a setting has been made so that a given image is to be formed on the back side. After that, the recording sheet is fed to the downstream side from the recording unit 24 in the sheet-feeding direction, and then discharged to the discharge tray 21. The ink-drying time A is set in the maintenance process to be performed in Step 110.

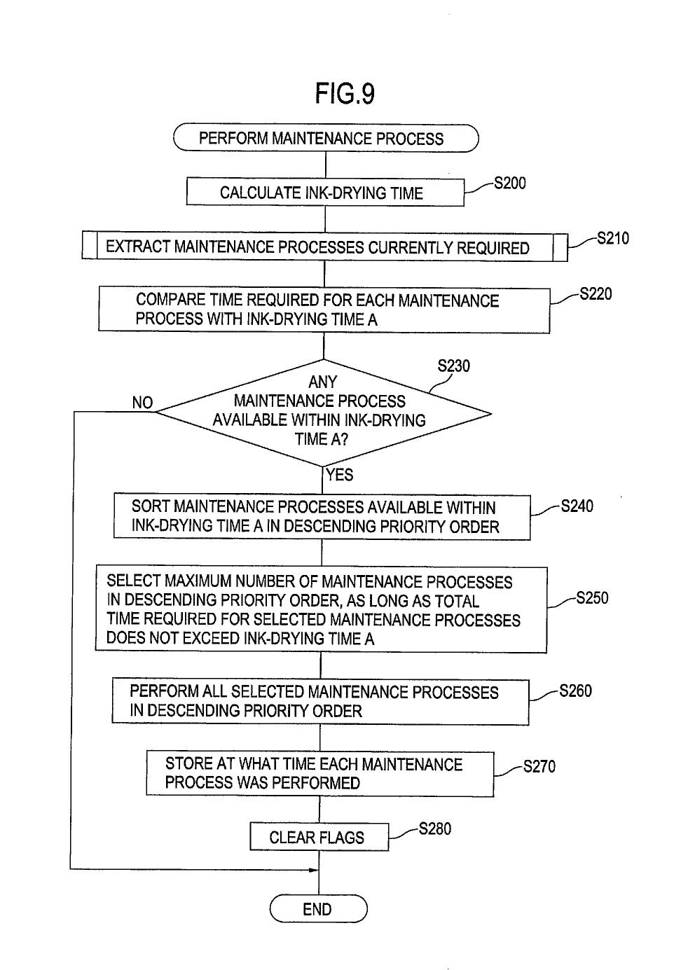

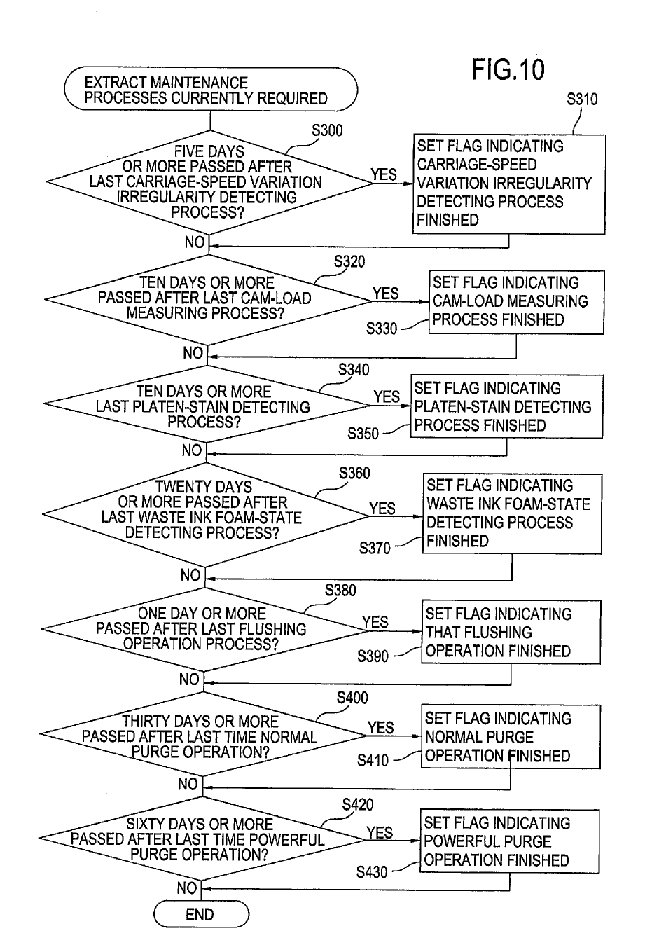

Referring to the flowcharts of FIG. 9 and FIG. 10, the maintenance process is described. In Step 200 of FIG. 9, the CPU 88 calculates an ink-drying time A. The ink-drying time A is a time period required for drying the ink applied on the front side of the recording sheet. Specifically, the CPU 88 calculates how much ink is to be applied on the front side (total ink application amount) from the image data used for forming the image on the front side. The CPU 88 then calculates the ink-drying time A from the total ink application amount and the type of the recording sheet, based on a table shown as Table 1.

TABLE 1

| Sheet type | Ink application amount M | Ink-drying time A |
|---|---|---|
| Plain paper | 0 ≦ M < m1 | A = Ta1 |
| | m1 ≦ M < m2 | A = Ta2 |
| | m2 ≦ M < m3 | A = Ta3 |
| | m3 ≦ M | A = Ta4 |
| Coated paper | 0 ≦ M < m1 | A = Tb1 |
| | m1 ≦ M < m2 | A = Tb2 |
| | m2 ≦ M < m3 | A = Tb3 |
| | m3 ≦ M | A = Tb4 |
| Glossy paper | 0 ≦ M < m1 | A = Tc1 |
| | m1 ≦ M < m2 | A = Tc2 |
| | m2 ≦ M < m3 | A = Tc3 |
| | m3 ≦ M | A = Tc4 |

(In Table 1, m1 < m2 < m3, Ta1 < Ta2 < Ta3 < Ta4, Tb1 < Tb2 <
Tb3 < Tb4, and Tc1 < Tc2 < Tc3 < Tc4)

The table shown as Table 1 has been stored in the ROM 89 (see FIG. 7). The type of the recording sheet has been set by the user through the operation panel 40.

In Step 210, the CPU 88 extracts one or more maintenance processes currently required, from all the maintenance processes which have been stored. Specifically, the ROM 89 (see FIG. 7) of the multi-functional printer 10 stores programs for performing the following maintenance processes to maintain the performance of the multi-functional printer 10 (printing unit 11 in particular): (1) a carriage-speed variation irregularity detecting process; (2) a cam-load measuring process; (3) a platen-stain detecting process; (4) a waste ink foam-state detecting process; (5) a flushing operation; (6) a normal purge operation; and (7) a powerful purge operation. From these maintenance processes, the CPU 88 extracts one or more maintenance processes required at a current point of time. The maintenance processes (1) to (7) will be described later in detail.

The process of Step 210 is described in detail with reference to the flowchart of FIG. 10. In Step 300, the CPU 88 determines whether or not five days or more have passed since the last time when the carriage (CR)-speed variation irregularity detecting process was performed, on a time basis. If five days or more have passed, in Step 310, the CPU 88 sets a flag indicating that the carriage-speed variation irregularity detecting process has been finished, and then proceeds to Step 320. On the other hand, if five days or more have not passed yet, the CPU 88 proceeds straight to Step 320.

In Step 320, the CPU 88 determines whether or not ten days or more have passed since the last time when the cam-load measuring process was performed, on the time basis. If ten days or more have passed, in Step 330, the CPU 88 sets a flag indicating that the cam-load measuring process has been finished, and then proceeds to Step 340. On the other hand, if ten days or more have not passed yet, the CPU 88 proceeds straight to Step 340.

In Step 340, the CPU 88 determines whether or not ten days or more have passed since the last time when the platen-stain detecting process was performed, on the time basis. If ten days or more have passed, in Step 350, the CPU 88 sets a flag indicating that the platen-stain detecting process has been finished, and then proceeds to Step 360. On the other hand, if ten days or more have not passed yet, the CPU 88 proceeds straight to Step 360.

In Step 360, the CPU 88 determines whether or not twenty days or more have passed since the last time when the waste ink foam-state detecting process was performed, on the time basis. If twenty days or more have passed, in Step 370, the CPU 88 sets a flag indicating that the waste ink foam-state detecting process has been finished, and then proceeds to Step 380. On the other hand, if twenty days or more have not passed yet, the CPU 88 proceeds straight to Step 380.

In Step 380, the CPU 88 determines whether or not a day or more have passed since the last time when the flushing operation process was performed, on the time basis. If a day or more have passed, in Step 390, the CPU 88 sets a flag indicating that the flushing process has been finished, and then proceeds to Step 400. On the other hand, if a day or more have not passed yet, the CPU 88 proceeds straight to Step 400.

In Step 400, the CPU 88 determines whether or not thirty days or more have passed since the last time when the normal purge operation was performed, on the time basis. If thirty days or more have passed, in Step 410, the CPU 88 sets a flag indicating that the normal purge operation has been finished, and then proceeds to Step 420. On the other hand, if thirty days or more have not passed yet, the CPU 88 proceeds straight to Step 420.

In Step 420, the CPU 88 determines whether or not sixty days or more have passed since the last time when the powerful purge operation was performed, on the time basis. If sixty days or more have passed, in Step 430, the CPU 88 sets a flag indicating that the powerful purge operation has been finished, and then proceeds to Step 440. On the other hand, if sixty days or more have not passed yet, the CPU 88 proceeds straight to Step 440. Each of the flags is set in the EEPROM 91 (see FIG. 7).

Referring again to the flowchart of FIG. 9, in Step 220, the CPU 88 compares the time required for performing each maintenance process for which the flag has been set in Step 210, with the ink-drying time A calculated in Step 200. The times required for performing the maintenance processes have been stored in the ROM 89 (see FIG. 7) in the form of Table 2.

TABLE 2

| | Required time | |
|---|---|---|
| Maintenance process | (sec.) | Priority |
| Carriage-speed variation | 30 | 4 |
| irregularity detection | | |
| Cam-load measurement | 40 | 7 |
| Platen-stain detection | 20 | 6 |
| Waste ink foam-state | 50 | 5 |
| detection | | |
| Flushing | 10 | 3 |
| Normal purge | 60 | 2 |
| Powerful purge operation | 120 | 1 |

In Step 230, the CPU 88 determines whether or not at least one maintenance process can be performed within the ink-drying time A (requires a time equal to or shorter than the ink-drying time A), based on the comparison result obtained in Step 220. If YES, the CPU 88 proceeds to Step 240. If NO, the CPU 88 ends the process.

In Step 240, the CPU 88 sorts the maintenance processes which can be performed within the ink-drying time A in the order of descending priorities. As shown in Table 2, the priorities of all the maintenance processes have been set and stored in the ROM 89 (see FIG. 7). In Table 2, the process to which the number “1” is assigned has the highest priority while the process to which the number “7” is assigned has the lowest priority.

In Step 250, from the maintenance processes sorted in the order of descending priorities in the Step 230, the CPU 88 selects a maximum number of maintenance processes in the order of descending priorities, as long as the total time required for performing the selected maintenance processes does not exceed the ink-drying time A. For example, the following case is assumed: the ink-drying time A is 100 seconds, the time required for performing the maintenance process having the highest priority is 60 seconds, the time required for performing the maintenance process having the second highest priority is 10 seconds, and the time required for performing the maintenance process having the third highest priority is 40 seconds. In this case, the total time required for performing the highest prioritized maintenance process and the second highest prioritized maintenance process is 70 seconds, which does not exceed the ink-drying time A. However, if the third highest prioritized maintenance process is further added, the total required time becomes 110 seconds, which exceeds the ink-drying time A. Therefore, the CPU 88 selects the highest prioritized maintenance process and the second highest prioritized maintenance process in this case.

In Step 260, the CPU 88 performs all the maintenance processes selected in Step 250, in the order of descending priorities. In Step 270, the CPU 88 stores, in the EEPROM 91, the time each maintenance process was performed (see FIG. 7). In Step 280, the CPU 88 clears all the flags set in Step 210. If the single-sided print mode has been set, the multi-functional printer 10 can form an image only on one side of the recording sheet in a well-known method, and the description of the process of performing in the single-sided print mode is omitted here.

The maintenance processes which the multi-functional printer 10 can perform are described with reference to FIGS. 3 and 4.

(1) Carriage-Speed Variation Irregularity Detecting Process

The carriage-speed variation irregularity detecting process is described in terms of its corresponding configuration and operation. The control unit 84 (see FIG. 7) detects the position of the carriage 38 at a plurality of sites along the path on which the carriage 38 reciprocates, by using the linear encoder 85. Based on the detected positions and the points of time when the positions were detected, the control unit 84 then detects the irregularity of the variation in the speed of the carriage 38 along the reciprocating path. If the irregularity of the variation in the speed of the carriage 38 exceeds a predetermined threshold value, the operation panel 40 informs the user accordingly.

(2) Cam-Load Measuring Process

For the cam-load measuring process, the control unit 84 moves the carriage 38 and pushes the contact lever (not shown), so as to operate the lifting-up mechanism 155. The control unit 84 then detects the speed of the carriage 38 at this point of time by using the linear encoder 85. As the load during the operation of the lifting-up mechanism 155 (cam load) becomes heavier, the speed of the carriage 38 for pushing the contact lever becomes lower. Therefore, by detecting the speed of the carriage 38, the load during the operation of the lifting-up mechanism 155 can be detected. If the cam load exceeds a predetermined threshold value, the operation panel 40 informs the user accordingly.

(3) Platen-Stain Detecting Process

For the platen-stain detecting process, the control unit 84 detects the output value of the media sensor 86 in a state that no recording sheet P is placed on the platen 42. As the stain on the platen 42 becomes more terrible, the output value of the media sensor 86 becomes smaller. Therefore, based on the output value, the control unit 84 determines how terrible the stain on the platen 42 is. If the stain on the platen 42 exceeds a predetermined threshold value, the operation panel 40 informs the user accordingly.

The media sensor 86 further has a function of detecting the presence or absence of the recording sheet on the platen 42, based on the difference between the output values obtained when the recording sheet P has been fed onto the platen 42, and when the recording sheet P has not been fed onto the platen 42 yet.

(4) Waste Ink Foam-State Detecting Process

For the waste ink foam-state detecting process, the control unit 84 moves the carriage 38 so that the media sensor 86 is positioned immediately above the waste ink tray 57. The media sensor 86 then detects the light reflected from the waste ink tray 57. As the amount of the ink discharged to the waste ink tray 57 becomes larger, the output value of the media sensor 86 becomes smaller. Therefore, based on the output value, the control unit 84 detects the state of the waste ink tray 57. The amount of the ink absorbed in the waste ink form exceeds a predetermined threshold value, the operation panel 40 informs the user accordingly.

(5) Flushing

The control unit 84 moves the carriage 38 so that the ink-jet recording head 39 is positioned immediately above the waste ink tray 57. The control unit 84 then has the ink-jet recording head 39 eject ink without printing (flushing). The ejected ink adheres onto the waste ink tray 57. The flushing operation is a maintenance process for maintaining the performance of the ink-jet recording head 39.

(6) Normal Purge and (7) Powerful Purge

The control unit 84 moves the carriage 38 so that the ink-jet recording head 39 is positioned above the nozzle cap 152 and the exhaust cap 153. The control unit 84 then brings the nozzle cap 152 and the exhaust cap 153 into close contact with the nozzle surface and the port of the ink-jet recording head 39. In this state, the pump 154 removes air bubbles and the like from the ink-jet recording head 39 by suction (purge). If a purge is performed by a relatively weak power, the purge operation corresponds to the normal purge. If a purge is performed by a power stronger than that in the normal purge, the purge operation corresponds to the powerful purge. The normal purge operation and the powerful purge operation are processes for maintaining the performance of the ink-jet recording head 39.

The multi-functional printer 10 has the following effects.

(i) The multi-functional printer 10 performs one or more maintenance processes for maintaining the performance of the multi-functional printer 10 within the ink-drying time A arising between when an image is formed on the front side of a recording sheet, and when another image is formed on the back side thereof. Therefore, the ink-drying time A can be utilized effectively. No other maintenance processes are required.

(ii) The maintenance processes are performed after the image forming on the front side of the recording sheet is finished, before the image forming on the back side thereof is started. Therefore, the quality of the image formed on the back side can be improved.

(iii) From the maintenance processes (1) to (7), the multi-functional printer 10 extracts and performs one or more maintenance processes required at a current point of time. Effective maintenance can be carried out.

(iv) The multi-functional printer 10 prioritizes the maintenance processes, and then selects one or more maintenance processes required in the order of descending priorities. Therefore, even when the ink-drying time A is short, effective maintenance can be carried out.

(v) The multi-functional printer 10 varies the ink-drying time A according to the total ink application amount and the recording sheet type. The multi-functional printer 10 selects one or more appropriate maintenance processes according to the varied ink-drying time A. Therefore, the ink-drying time A can be utilized effectively, thereby carrying out effective maintenance.

Although the present invention has been described with respect to specific embodiments, it will be appreciated by one skilled in the art that a variety of changes may be made without departing from the scope of the invention.

For example, a sensor included in the multi-functional printer 10 may detect the recording status on the front side of the recording sheet (amount of ink, how well the ink is dried, and the like). Based on the detected result, the ink-drying time A can be set. This allows an appropriate drying time to be set according to the image actually formed on the recording sheet.

For the method of setting the ink-drying time A, in addition to the aforementioned method in which the multi-functional printer 10 sets the ink-drying time A automatically, the method may be employed, in which the user inputs the setting manually through the operation panel 40.

In order to set the ink-drying time A, the table shown as Table 3 may be employed, instead of the table shown as Table 1. In this table, the ink-drying time A is set regardless of recording sheet type, thereby simplifying the processes.

TABLE 3

| Ink application amount M | Ink-drying time A |
|---|---|
| 0 ≦ M < m1 | A = T1 |
| m1 ≦ M < m2 | A = T2 |
| m2 ≦ M < m3 | A = T3 |
| m3 ≦ M | A = T4 |

(In Table 3, m1 < m2 < m3, and T1 < T2 < T3 < T4)

What is claimed is:

1. An ink-jet recording device comprising:
an image forming unit configured to form an image on a recording medium having a first surface and a second surface, the image forming unit including a recording head configured to eject ink droplets onto the first surface to form a first image thereon, and configured to eject ink droplets onto the second surface to form a second image thereon after forming the first image; and
a maintenance-process performing unit configured to perform a maintenance process for improving a quality of the second image, within a standby time period after forming of the first image is finished and before forming of the second image is started.

2. The ink-jet recording device according to claim 1, further comprising a standby unit configured to keep the recording medium on it's standby phase for the standby time period.

3. The ink-jet recording device according to claim 1, wherein the maintenance-process performing unit performs the maintenance process for improving a performance of the image forming unit.

4. The ink-jet recording device according to claim 3, wherein the maintenance-process performing unit performs the maintenance process for improving a performance of the recording head.

5. The ink-jet recording device according to claim 1, further comprising:
a maintenance-process storing unit configured to store a plurality of maintenance processes;
a determining unit configured to determine whether or not each of the plurality of maintenance processes is to be performed in order to improve the quality of the second image; and
a selecting unit configured to select one or more maintenance processes which can be performed within the standby time period, from the maintenance processes which has been determined to be performed by the determining unit,
wherein the maintenance-process performing unit performs the one or more maintenance processes selected by the selecting unit.

6. The ink-jet recording device according to claim 5, further comprising a priority storing unit configured to store priorities of the plurality of maintenance processes stored in the maintenance-process storing unit,
wherein the selecting unit selects one or more maintenance processes which can be performed within the standby time period in accordance with the priorities stored in the priority storing unit.

7. The ink-jet recording device according to claim 5, further comprising a processing time storing unit configured to store processing time required for performing each of the plurality of maintenance processes stored in the maintenance-process storing unit,
wherein the selecting unit selects one or more maintenance processes which can be performed within the standby time period, based on the processing time.

8. The ink-jet recording device according to claim 5, further comprising a standby time period varying unit configured to vary the standby time period.

9. The ink-jet recording device according to claim 8, further comprising a calculating unit configured to calculate a recording status of the first surface,
wherein the standby time period varying unit varies the standby time period based on the recording status.

10. The ink-jet recording device according to claim 9, wherein the calculating unit calculates the recording status based on an amount of image data for forming the first image on the first surface.

11. The ink-jet recording device according to claim 9, further comprising a detecting unit configured to detect the recording status.

12. An ink-jet recording method in an ink-jet recording device configured to form a first image on a first surface of a recording medium, and configured to form a second image on a second surface of the recording medium, the method comprising:
forming the first image; and
performing a maintenance process for improving a quality of the second image, after forming of the first image is finished and before forming of the second image is started.
